(19) United States
(12) Patent Application Publication
(10) Pub. No.: US 2015/0193081 A1
(43) Pub. Date: Jul. 9, 2015

(54) SENSING ELECTRODE AND SENSING ELECTRODE UNIT

(71) Applicant: MStar Semiconductor, Inc., Hsinchu Hsien (TW)

(72) Inventor: Tzu-Wei Liu, Zhubei City (TW)

(21) Appl. No.: 14/583,998

(22) Filed: Dec. 29, 2014

(30) Foreign Application Priority Data
Jan. 3, 2014 (TW) 103100250

(51) Int. Cl. G06F 3/041

(52) U.S. Cl. CPC G06F 3/0418

(57) ABSTRACT

A sensing electrode unit is provided. The sensing electrode, repeatedly arranged to form a part of a sensing electrode, includes a first electrode, a second electrode having a planar contour corresponding to that of the first electrode, and a third electrode. At least one part of the third electrode is parallel to one side of the first electrode and one side of the second electrode.

This application claims the benefit of Taiwan application Serial No. 103100250, filed Jan. 3, 2014, the subject matter of which is incorporated herein by reference.

### BACKGROUND OF THE INVENTION

1. Field of the Invention

The invention relates in general to a sensing electrode and a sensing electrode unit of a touch panel, and more particularly, to a sensing electrode and a sensing electrode unit adapted to detect noise interference on a touch panel.

2. Description of the Related Art

Touch panels make a large scale industry. Various electronic products adopt touch panels as critical input/output devices for human-machine interfaces. The performance of touch panels depends on sensing electrodes and logic circuits connected thereto. Thus, the design and quality of the sensing electrodes dominate the performance of touch panels.

The sensing electrodes of a touch panel are generally formed on a transparent substrate. Light emitted from a display device penetrates the transparent substrate to reach a user. These sensing electrodes formed on the transparent substrate include multiple electrodes, which are connected to the logic circuits via multiple conducting wires. By detecting a minute current on the sensing electrode, the touch panel accordingly learns a proximity (approach or contact) event occurring on the touch panel.

An electronic device installed with a touch panel is frequently interfered by electromagnetic in the environment. Especially in a modernized living environment, high-voltage alternating currents provided by public electricity networks are likely to pose interference on the touch panel. Although an electronic device may be provided with ground measures, such minute current may still reach a sensing electrode of a touch panel via a user body such as a finger or a stylus, leading to a change in electrical characteristics of the sensing electrode.

Therefore, there is a need for a sensing electrode design capable of detecting alternating current noise, so as to detect noise interference from an external while detecting a proximity event to further provide a more accurate determination result for the proximity event.

### SUMMARY OF THE INVENTION

According to an embodiment the present invention, a sensing electrode unit is provided. The sensing electrode unit, repeatedly arranged to form a part of a sensing electrode, includes a first electrode, a second electrode having a planar contour corresponding to that of the first electrode, and a third electrode. At least one part of the third electrode is parallel to one side of the first electrode and one side of the second electrode.

According to another embodiment of the present invention, a sensing electrode is provided. The sensing electrode includes a first sensing electrode unit and a second sensing electrode unit. The first sensing electrode unit includes a first electrode, a second electrode having a planar contour corresponding to that of the first electrode, and a third electrode. At least one part of the third electrode is parallel to one side of the first electrode and one side of the second electrode. The second electrode includes a fourth electrode having a planar contour different from those of the first electrode and the second electrode, a fifth electrode having a planar contour corresponding to that of the fifth electrode, and a sixth electrode. At least one part of the sixth electrode is parallel to one side of the fourth electrode and one side of the fifth electrode.

According to yet another embodiment of the present invention, a sensing electrode is provided. The sensing electrode includes: a first sensing electrode group, including a plurality of first sensing electrode units; and a second sensing electrode group, parallel to the first sensing electrode group, include a plurality of the first sensing electrode units. Each of the first sensing electrodes includes a first electrode, a second electrode having a planar contour corresponding to that of the first electrode, and a third electrode. At least one part of the third electrode is parallel to one side of the first electrode and one side of the second electrode.

Via a third conducting wire connected to the third electrode, multiple scanning operations for noise may be performed during one sensing operation performed by the sensing electrode unit. Thus, an alternating current period and an alternating current noise amount inputted from an external can be learned to accordingly deduct the alternating current noise amount from a sensing amount obtained by the sensing electrode unit, thereby providing enhancing the accuracy of the sensing amount.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A is a schematic diagram of a sensing electrode 100 according to an embodiment of the present invention;

FIG. 1B is a schematic diagram of a sensing electrode 100 according to another embodiment of the present invention;

FIG. 2 is a schematic diagram of a sensing electrode 200 according to an embodiment of the present invention;

FIG. 3 is a schematic diagram of a sensing electrode 300 according to another embodiment of the present invention;

FIG. 4A is a schematic diagram of a sensing electrode 400 according to another embodiment of the present invention;

FIG. 4B a schematic diagram of a sensing electrode 400 according to another embodiment of the present invention;

FIG. 5A is a schematic diagram of a sensing electrode 500 according to an embodiment of the present invention;

FIG. 5B is a schematic diagram of a sensing electrode 500 according to another embodiment of the present invention;

FIG. 6 is a schematic diagram of a sensing electrode 600 according to another embodiment of the present invention; and

FIG. 7A to FIG. 7H are schematic diagrams of a sensing electrode 700 according to other embodiments of the present invention.

### DETAILED DESCRIPTION OF THE INVENTION

Some embodiments are described in detail below. The scope of the present invention is not limited by the description of the embodiments, but is to be defined in accordance with the appended claims. To better describe and explain contents of the present invention to one person skilled in the art, different parts in the diagrams are not drawn according to real sizes or ratios, and certain sizes and associated scales may be enlarged for better distinction. Further, irrelevant details may be omitted to maintain the simplicity of the diagrams for better understanding.

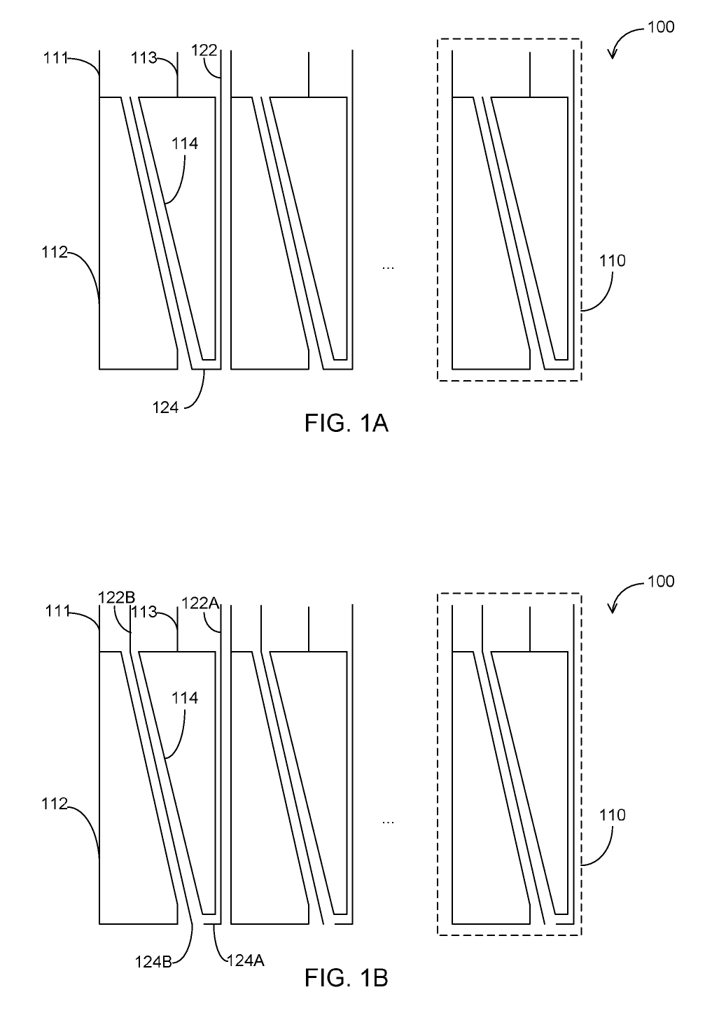

FIG. 1A shows a schematic diagram of a sensing electrode 100 according to an embodiment of the present invention. The sensing electrode 100 is a part of a touch panel. In FIG. 1A, the sensing electrode 100 includes a plurality of sensing electrode units 110 arranged into one row, e.g., the part included in the dotted frame. Each of the sensing electrode units 110 includes a first conducting wire 111, a first electrode 112 connected to the first conducting wire 111, a second conducting wire 113, a second electrode 114 connected to the second conducting wire 113, a third conducting wire 122, and a third electrode 124 connected to the third conducting wire 122.

The first electrode 112 and the second electrodes 114 are sensing electrodes having corresponding planar contours. For example, the planar contour may be a triangle, a trapezoid, or the triangle-like shape in FIG. 1A. In the embodiment, the planar contour of the first electrode 112 exactly mirrors the planar contour of the second electrode 114 along an axis. In another embodiment, the planar contour of the first electrode 112 may be different from the planar contour of the second electrode 114. Provided that the first electrode 112 and the second electrode 114 have parallel corresponding sides and complementary boundaries, such sensing electrodes are regarded as sensing electrodes having corresponding planar contours. One person skilled in the art can understand that, considering the manufacturing yield rate, in an electrode on the substrate, a bending section manufactured as an acute angle bears a greater possibility for breakage, or an intended shape may not be successfully manufactured. In contrast, by designing a bending section as a right angle or an obtuse angle, the manufacturing yield rate may be raised. Hence, it is suggested that acute angles be avoided in designing the planar contours of the first electrode 112 and the second electrode 114. In the embodiment, two sides of the first electrode 112 are perpendicular to each other, and two sides of the second electrodes 114 are also perpendicular to each other. Respective third sides of the first electrode 112 and the second electrode 114 are parallel to respectively form third sides of respective triangles or triangle-like shapes. The first electrode 112 and the second electrode 114 are connected to a processing module via the first conducting wire 111 and the third conducting wire 113, respectively. The processing module is applied to sense a proximity event. Details of associated sensing mechanism are known to one person skilled in the art, and shall be omitted herein.

Via the third conducting wire 122, the third electrode 124 is connected to an alternating current (AC) noise processing module, which processes an alternating current sensed by the third electrode 124. The AC noise processing module has identical functions as the above processing module, or may be a special processing module. In the embodiment in FIG. 1A, at least one part of the third electrode 124 is parallel to the third sides of the first electrode 112 and the second electrode 114, and is routed below the second electrode 114 and then along a periphery of the sensing electrode unit 110 to further connect at the top to the third conducting wire 122. In one embodiment, at least one part of the third electrode 124 is spaced from the first electrode 112 and the second electrode 114 by equal distances.

FIG. 1B shows a schematic diagram of a sensing electrode 100 according to another embodiment of the present invention. FIG. 1B is substantially similar to FIG. 1A, and so details of the same denotations can be referred from the description on the embodiment in FIG. 1A. A main difference of FIG. 1B from FIG. 1A is that, the third electrode 122 is divided into two separate parts. A third A electrode 124A is routed along a periphery of the sensing electrode 110 to connect at the top to a third A conducting wire 122A. A part of the third B electrode 124A is parallel to the third sides of the first electrode 112 and the second electrode 114, and is connected at the top to a third B electrode 122B.

A disconnection point of the third A electrode 124A and the third B electrode 124B may be at the bottom of the sensing electrode unit. As shown in FIG. 1B, the third A electrode 124A still extends to the bottom of the sensing electrode unit. In another embodiment, the third A electrode A does not extend to the bottom of the sensing electrode unit, and is located between two sensing electrode units. In one embodiment, the third A electrode 124A is spaced from two sensing units at its right and left by equal distances.

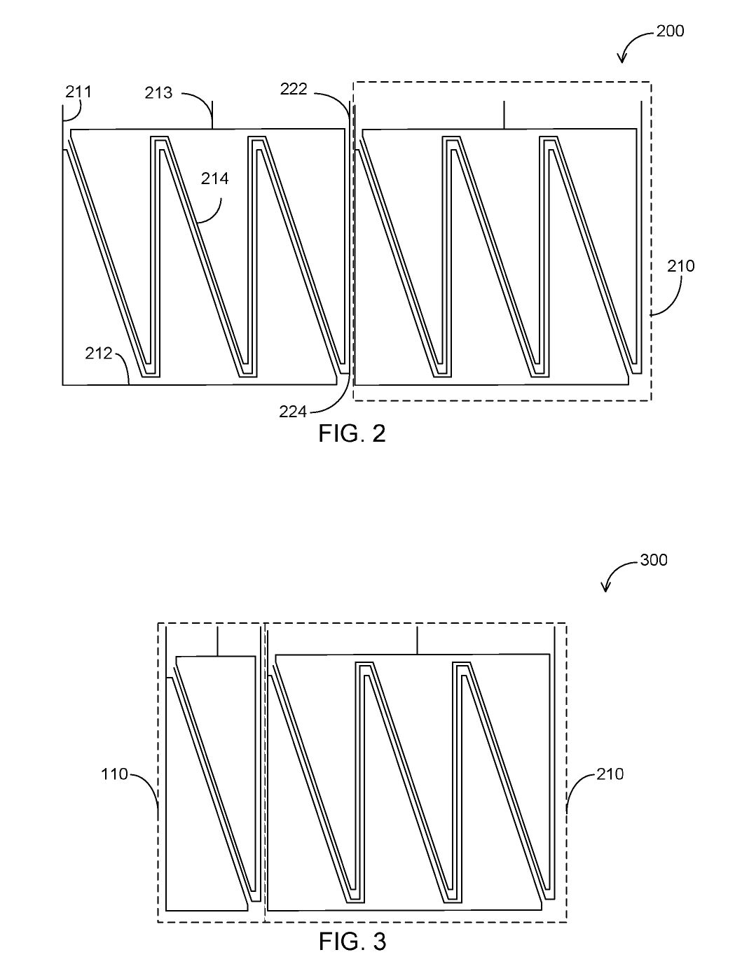

FIG. 2 shows a schematic diagram of a sensing electrode 200 according to an embodiment of the present invention. The sensing electrode 200 is a part of a touch panel. The sensing electrode 200 similarly includes a plurality of sensing electrode units 210 arranged in one row. Each of the sensing electrode units 210 includes a first conducting wire 211, a first electrode 212 connected to the first conducting wires 211, a second conducting wire 213, a second electrode 214 connected to the second conducting wire 213, a third conducting wire 222, and a third electrode 224 connected to the third conducting wire 222.

The first electrode 212 and the second electrodes 214 are sensing electrodes having corresponding planar contours. For example, the planar contour may be a triangle, a trapezoid, or the triangle-like shape. One person skilled in the art can understand that, considering the manufacturing yield rate, in an electrode on the substrate, a bending section manufactured as an acute angle bears a greater possibility for breakage, or an intended shape may not be successfully manufactured. In contrast, by designing a bending section as a right angle or an obtuse angle, the manufacturing yield rate may be raised. Hence, it is suggested that acute angles be avoided in designing the planar contours of the first electrode 212 and the second electrode 214. In the embodiment, two sides of the first electrode 212 are perpendicular to each other, and two sides of the second electrodes 214 are also perpendicular to each other. In addition to these two sides, the first electrode 212 further includes a boundary that is parallel and corresponding to a boundary of the second electrode 214. The first electrode 212 and the second electrode 214 are connected to a processing module via the first conducting wire 211 and the third conducting wire 213, respectively. The processing module is for sensing a proximity event, and details thereof are omitted herein.

Via the third conducting wire 222, the third electrode 224 is connected to an AC noise processing module, which processes an alternating current sensed by the third electrode 224 to further eliminate AC noise generated by a charger. The AC noise processing module has functions similar to that above processing module, or may be a special processing module. In the embodiment in FIG. 2, at least one part of the third electrode 224 is parallel to the parallel sides of the first electrode 212 and the second electrode 212. After passing below the second electrode 224, a route is arranged along a periphery of the sensing electrode unit 210 to connect at the top to the third connecting wire 222. In one embodiment, the least one part of the third electrode 224 spaced from the parallel sides of the first electrode 212 and the second electrode 212 by equal distances.

FIG. 3 shows a schematic diagram of a sensing electrode 300 according to another embodiment of the present invention. The sensing electrode 300 is a part of a touch panel. The sensing electrode 300 includes two different types of electrodes 110 and 210. Details of these two types of electrodes 110 and 210 are described in the embodiments in FIG. 1A and FIG. 1B, and shall be omitted herein. In one embodiment, the sensing electrode unit 110 may be arranged at a border of the sensing electrode 300, and the sensing electrode unit 210 may be arranged at a center of the sensing electrode 300 to form one row.

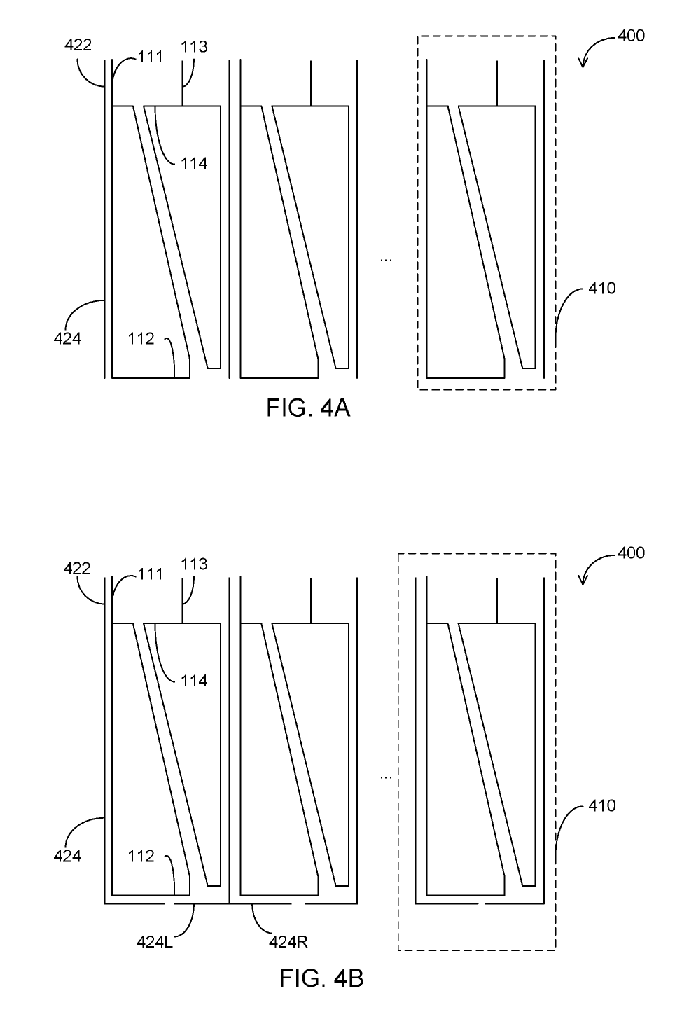

FIG. 4A shows a schematic diagram of a sensing electrode 400 according to an embodiment of the present invention. The sensing electrode 400 is a part of a touch panel. The sensing electrode 400 includes a plurality of sensing electrode units 410 arranged in one row, e.g., the part in the dotted frame. The sensing electrode unit 410 is substantially similar to the sensing electrode 110 in FIG. 1A. A main difference of the sensing electrode 410 from the sensing electrode 110 in FIG. 1A is that, a third electrode 424 that connected upwards to a third conducting wire 422 is distributed only at a side of the sensing electrode unit 410, e.g., the left side of the first electrode 112 or the right side of the second electrode 114, unlike the third electrode 124 which extended to the third sides of first electrode 112 and the second electrode 114.

FIG. 4B shows a schematic diagram of a sensing electrode 400 according to another embodiment of the present invention. A main difference of the embodiment in FIG. 4 is that, apart from being distributed at the left side of the first electrode 112 or the right side of the second electrode 114, a third electrode 424 extendedly includes a third left electrode 424L and/or a third right electrode 424R. In the embodiment, the third left electrode 424L and the third right electrode 424R have substantially equal lengths, and respectively surround a lower side of the sensing electrode unit 410. The above example of equal lengths of the third left electrode 424L and the third right electrode 424R does not limit the present invention. In other embodiments, the third left electrode 424L may have a length greater than that of the third right electrode 424R. In yet other embodiments, the third left electrode 424L may have a length smaller than that of the third right electrode 424R. In one embedment, the length of the third left electrode 424L or the length of the third right electrode 424R may even be zero. In other words, the third electrode 424 includes only the third left electrode 424L or the third right electrode 424R.

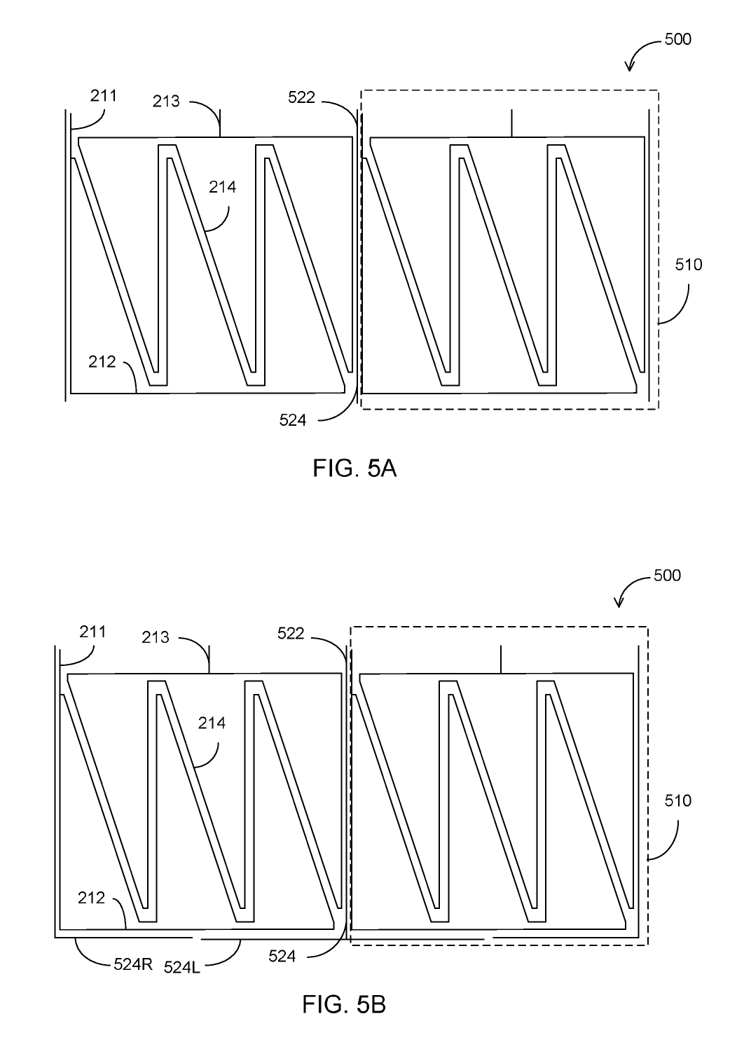

FIG. 5A shows a schematic diagram of a sensing electrode 500 according to another embodiment of the present invention. The sensing electrode 500 is a part of a touch panel. Compared to the sensing electrode unit 410 in FIG. 4A, a first electrode 212 and a second electrode 214 of a sensing electrode unit 510 in FIG. 5A includes multiple triangles, trapezoids, or triangle-like shapes. Associated details can be referred to the description of the embodiment in FIG. 2. Similar to the sensing electrode unit 410 in FIG. 4A, the sensing electrode unit 510 includes a third conducting wire 522 and a third electrode 524 connected to the third conducting wire 522. The third electrode 524 that connects at the top to the third conducting wire 522 is only distributed at a lateral side of the sensing electrode unit 510, e.g., the left side of the first electrode 212 or the right side of the second electrode 214.

FIG. 5B shows a schematic diagram of a sensing electrode 500 according to another embodiment of the present invention. A main difference of the embodiment in FIG. 5B from that in FIG. 5A is that, apart from being distributed at the left side of the first electrode 212 or the right side of the second electrode 214, a third electrode 524 extendedly includes a third left electrode 524L and/or a third right electrode 524R. In the embodiment in FIG. 5B, the third left electrode 524L and the third right electrode 524R have substantially equal lengths, and respectively surround a lower side of the sensing electrode unit 510. The above example of equal lengths of the third left electrode 524L and the third right electrode 524R is not a limitation to the present invention. In other embodiments, the third left electrode 524L may have a length greater than that of the third right electrode 524R. In yet other embodiments, the third left electrode 524L may have a length smaller than that of the third right electrode 524R. In one embedment, the length of the third left electrode 524L or the length of the third right electrode 524R may even be zero. In other words, the third electrode 524 includes only the third left electrode 524L or the third right electrode 524R.

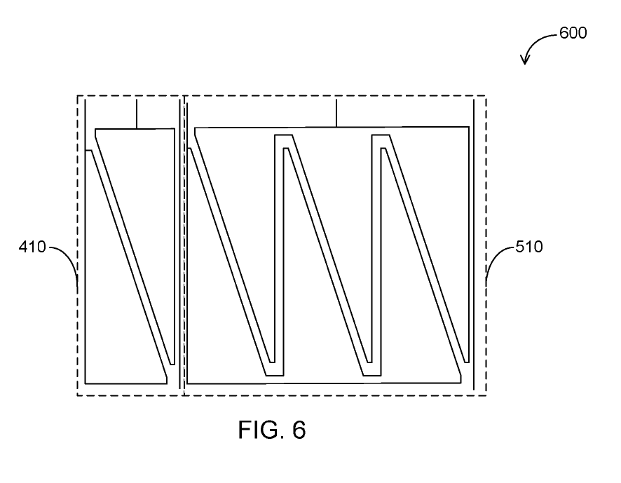

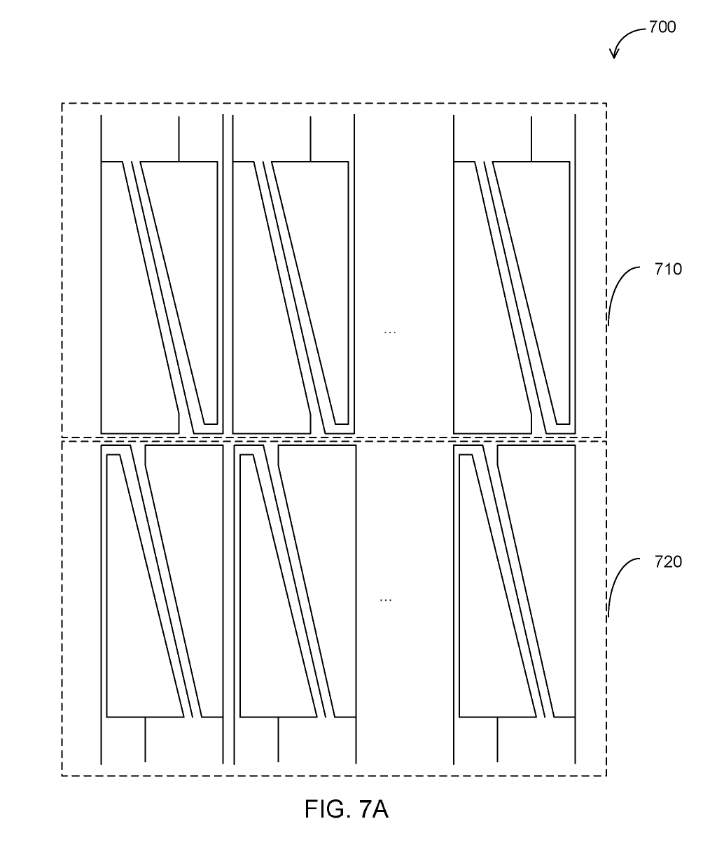

FIG. 6 shows a schematic diagram of a sensing electrode 600 according to another embodiment of the present invention. The sensing electrode 600 is a part of a touch panel. The sensing electrode 600 includes two different types of sensing electrode units 410 and 510. Details of these two types of sensing electrode units are described in the embodiments shown in FIG. 4A, FIG. 4B, FIG. 5A and FIG. 5B, and shall be omitted herein. In one embodiment, the sensing electrode unit 410 may be arranged at a border of the sensing electrode 600, and the sensing electrode unit 510 may be arranged at a center of the sensing electrode 600 to form one row.

Via a third conducting wire connected to the third electrode, multiple scanning operations for noise may be performed during one sensing operation performed by the sensing electrode unit. Thus, an alternating current period and an alternating current noise inputted from an external can be learned to accordingly deduct the alternating current noise from a sensing amount obtained by the sensing electrode unit, thereby providing enhancing the accuracy of the sensing amount.

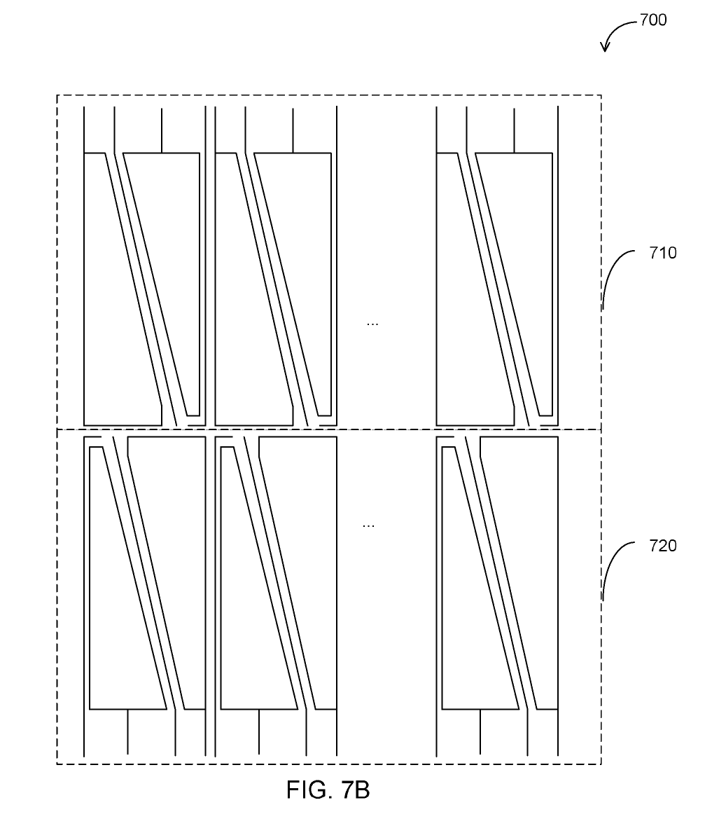

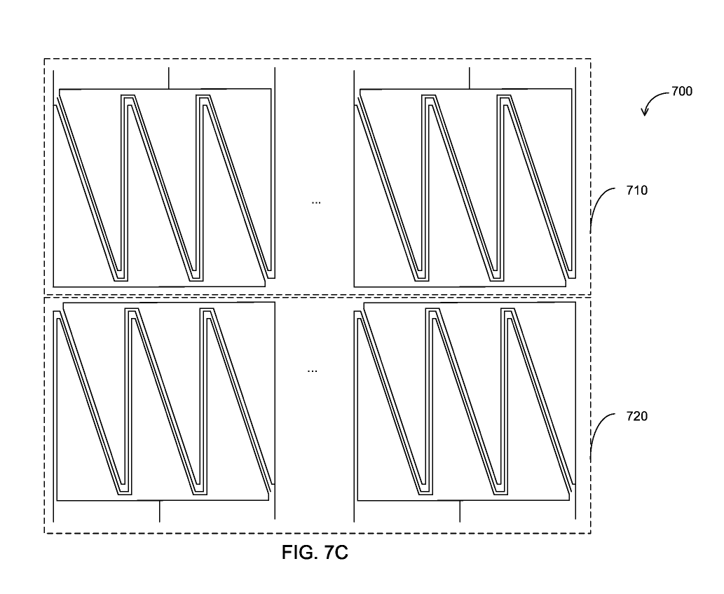

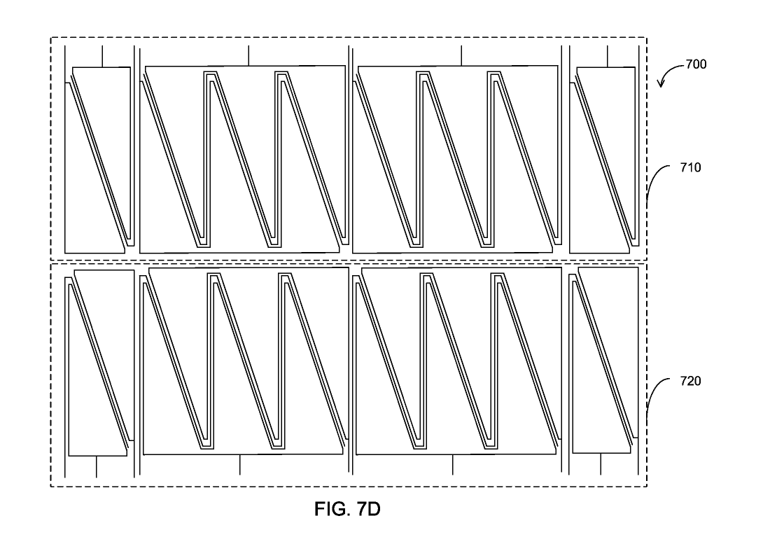

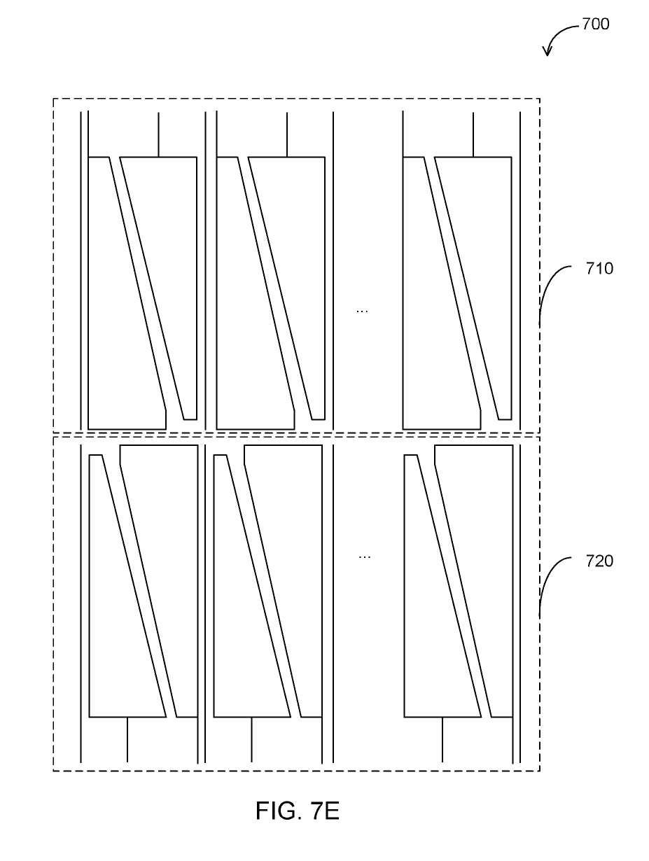

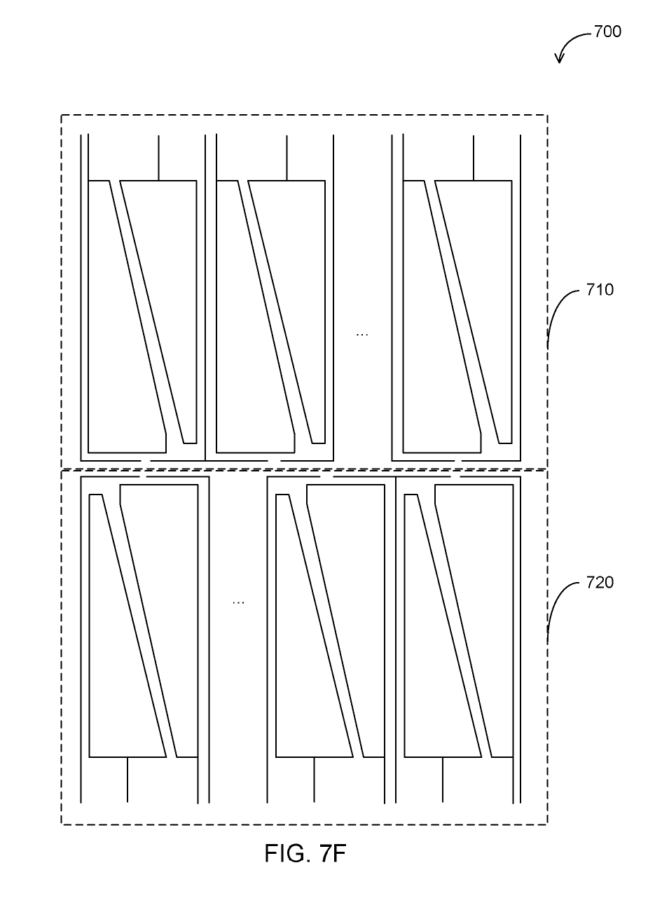

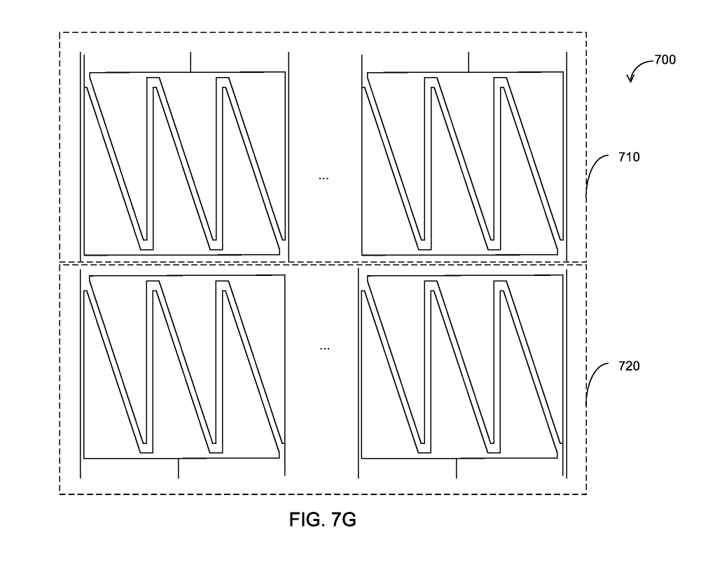

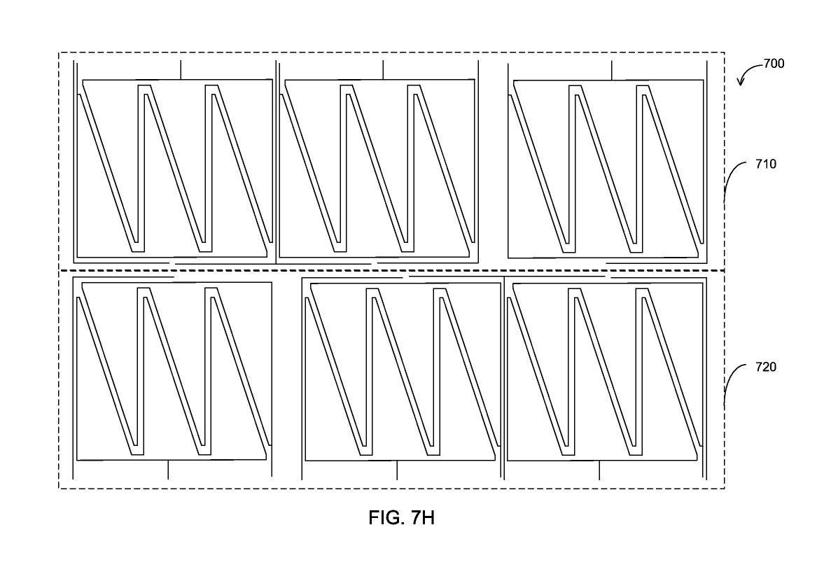

FIG. 7A to FIG. 7H are schematic diagrams of a sensing electrode 700 according to several embodiments of the present invention. The sensing electrode 700 is a part of a touch panel. The sensing electrode 700 shown in the eight diagrams includes a first sensing electrode group 710 and a second sensing electrode group 720 parallel to the first sensing group 710. Details and variations of previously described embodiments are applicable to the embodiments shown in these diagrams.

In the embodiment in FIG. 7A, again referring to the embodiment in FIG. 1A, a first sensing electrode group 710 includes multiple sensing electrode units 110 in FIG. 1A, and a second sensing electrode group 720 also includes multiple sensing electrodes 110 in FIG. 1A. The electrodes of the first sensing electrode group 710 and the second sensing electrode 720 connect to an exterior of the substrate along upward or downward directions.

In the embodiment in FIG. 7B, referring to the embodiment in FIG. 1B, the first sensing electrode group 710 includes multiple sensing electrode units 110 in FIG. 1B, and the second sensing electrode group 720 also includes multiple sensing electrodes 110 in FIG. 1B. The electrodes of the first sensing electrode group 710 and the second sensing electrode 720 connect to an exterior of the substrate along upward or downward directions.

In the embodiment in FIG. 7C, referring to the embodiment in FIG. 2, the first sensing electrode group 710 includes multiple sensing electrode units 210 in FIG. 2, and the second sensing electrode group 720 also includes multiple sensing electrodes 210 in FIG. 2. The electrodes of the first sensing electrode group 710 and the second sensing electrode 720 connect to an exterior of the substrate along upward or downward directions.

In the embodiment in FIG. 7D, referring to the embodiments in FIG. 1A to FIG. 3, the first sensing electrode group 710 includes multiple sensing electrode units 210 in FIG. 2, and the second sensing electrode group 720 includes multiple sensing electrode units 110 in FIG. 1A or FIG. 1B at a border of the second sensing electrode group 720. The electrodes of the first sensing electrode group 710 and the second sensing electrode 720 connect to an exterior of the substrate along upward or downward directions.

In the embodiment in FIG. 7E, referring to the embodiment in FIG. 4A, the first sensing electrode group 710 includes multiple sensing electrode units 410 in FIG. 4A, and the second sensing electrode group 720 also includes multiple sensing electrodes 410 in FIG. 4A. The electrodes of the first sensing electrode group 710 and the second sensing electrode 720 connect to an exterior of the substrate along upward or downward directions.

In the embodiment in FIG. 7F, referring to the embodiment in FIG. 4B, the first sensing electrode group 710 includes multiple sensing electrode units 410 in FIG. 4B, and the second sensing electrode group 720 also includes multiple sensing electrodes 410 in FIG. 4B. The electrodes of the first sensing electrode group 710 and the second sensing electrode 720 connect to an exterior of the substrate along upward or downward directions.

In the embodiment in FIG. 7G, referring to the embodiment in FIG. 5A, the first sensing electrode group 710 includes multiple sensing electrode units 510 in FIG. 5A, and the second sensing electrode group 720 also includes multiple sensing electrodes 510 in FIG. 5A. The electrodes of the first sensing electrode group 710 and the second sensing electrode 720 connect to an exterior of the substrate along upward or downward directions.

In the embodiment in FIG. 7H, referring to the embodiment in FIG. 5B, the first sensing electrode group 710 includes multiple sensing electrode units 510 in FIG. 5B, and the second sensing electrode group 720 also includes multiple sensing electrodes 510 in FIG. 5B. The electrodes of the first sensing electrode group 710 and the second sensing electrode 720 connect to an exterior of the substrate along upward or downward directions.

In conclusion, two parallel sensing electrode groups are included in the embodiments in FIG. 7A to FIG. 7H. Each of the sensing electrode groups includes multiple sensing electrode units. Each of the sensing electrode units includes a first electrode and a second electrode that have corresponding planar contours, and a third electrode. At least one part of the third electrode is parallel to one side of the first electrode and one side of the second electrode.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A sensing electrode unit, repeatedly arranged to form a part of a touch panel, the sensing electrode unit comprising:
a first electrode;
a second electrode, having a planar contour corresponding to that of the first electrode; and
a third electrode, at least one part of the third electrode being parallel to one side of the first electrode and one side of the second electrode;
wherein the first electrode and the second electrode are used to sense a proximity event, and the third electrode is used to sense noise.

2. The sensing electrode unit according to claim 1, wherein each of the first electrode and second electrode comprises two perpendicular sides.

3. The sensing electrode unit according to claim 2, wherein a distance from the at least one part of the third electrode to the first electrode is equal to a distance from the at least one part of the third electrode to the second electrode.

4. The sensing electrode unit according to claim 1, wherein the remaining part of the third electrode is distributed along one other side of the second electrode.

5. The sensing electrode unit according to claim 1, wherein each of the first electrode and second electrode comprises two perpendicular sides, a boundary of the first electrode is parallel and corresponding to a boundary of the second electrode, and the third electrode is distributed along the boundary of the first electrode and the boundary of the second electrode.

6. The sensing electrode unit according to claim 5, wherein a distance from the third electrode to the first electrode is equal to a distance from the third electrode to the second electrode.

7. The sensing electrode unit according to claim 1, wherein the third electrode is distributed along two perpendicular sides of the sensing electrode unit.

8. The sensing electrode unit according to claim 1, wherein the noise is deducted from a sensing amount detected by the first electrode and the second electrode.

9. The sensing electrode unit according to claim 1, wherein each angle of a planar contour of the third electrode is greater than or equal to a right angle.

10. The sensing electrode unit according to claim 1, wherein the first electrode, the second electrode and the third electrode are connected to a first conducting wire, a second conducting wire and a third conducting wire along a same direction of the sensing electrode unit.

11. A touch panel, comprising:
a first sensing electrode unit, comprising:
a first electrode;
a second electrode, having a planar contour corresponding to that of the first electrode; and
a third electrode, at least one part of the third electrode being parallel to one side of the first electrode and one side of the second electrode; and
a second sensing electrode unit, comprising:
a fourth electrode, having a planar contour different from those of the first electrode and the second electrode;
a fifth electrode, having a planar contour corresponding to that of the fifth electrode; and
a sixth electrode, at least one part of the sixth electrode being parallel to one side of the fourth electrode and one side of the fifth electrode;
wherein the first electrode, the second electrode, the fourth electrode and the fifth electrode are used to sense a proximity event, and the third electrode and the sixth electrode are used to sense noise.

12. A touch panel, comprising:
a first sensing electrode group, comprising a plurality of first sensing electrode units; and
a second sensing electrode group, parallel to the first sensing electrode group, comprising a plurality of first sensing electrode units;
wherein, each of the first sensing electrode units comprises:
a first electrode;
a second electrode, having a planar contour corresponding to that of the first electrode; and
a third electrode, at least one part of the third electrode being parallel to one side of the first electrode and one side of the second electrode;
wherein the first electrode and the second electrode are used to sense a proximity event, and the third electrode is used to sense noise.

13. The sensing electrode according to claim 12, wherein the first sensing electrode group further comprises at least one second sensing electrode unit, the second sensing electrode group further comprises at least one of the second sensing electrode unit, each of the second sensing electrode units comprises:
a fourth electrode, having a planar contour different from those of the first electrode and the second electrode;
a fifth electrode, having a planar contour corresponding to that of the fifth electrode; and
a sixth electrode, at least one part of the sixth electrode being parallel to one side of the fourth electrode and one side of the fifth electrode;
wherein the fourth electrode and the fifth electrode are used to sense a proximity event, and the sixth electrode is used to sense noise.

14. The sensing electrode according to claim 12, wherein the electrodes of the first sensing electrode group are respectively connected to respective conducting wires via a first side of the sensing electrodes, and the electrodes of the second sensing electrode group are respectively connected to respective connecting wires via a second side of the sensing electrodes, and the first side is opposite the second side.

15. The sensing electrode according to claim 12, wherein the third electrode detects noise, and the noise is deducted from a plurality of sensing amounts detected by the first electrode and the second electrode.
